(19) United States
(12) Patent Application Publication
(10) Pub. No.: US 2004/0078933 A1
(43) Pub. Date: Apr. 29, 2004

(54) Interchangeble decorative fascia for hardware piece

(76) Inventor: Earl D. Forrest, Asheboro, NC (US)

Correspondence Address: Edgar A. Zarins, Masco Corporation, 21001 Van Born Road, Taylor, MI, 48180, US

(21) Appl. No.: 10/306,708

(22) Filed: Nov. 27, 2002

Related U.S. Application Data
(60) Provisional application No. 60/420,978, filed on Oct. 24, 2002.

(51) Int. Cl. E05B 1/00

(52) U.S. Cl. 16/417

(57) ABSTRACT

A hardware piece applied to cabinetry or furniture to facilitate manipulation of doors and drawers or simply to add a decorative touch. The hardware piece has a removable fascia which allows the fascia member to be exchanged for a fascia of different color or design. The hardware piece includes a recess adapted to receive the fascia. A magnetic plate is used to maintain the fascia member within the recess. The magnetic attraction may be overcome in order to replace the fascia member.

### RELATED APPLICATIONS

This application claims priority from U.S. Provisional Application No. 60/420,978 filed on Oct. 24, 2002.

### BACKGROUND OF THE INVENTION

I. Field of the Invention

This invention relates to hardware pieces such as knobs and pulls used to accessorize cabinets and furniture and, in particular, to a hardware piece with an interchangeable fascia to selectively alter the decorative appearance of the hardware component.

II. Description of the Prior Art

Consumers have placed increased importance on the aesthetic or decorative aspects of their homes. In some instances, a room can be given an entirely new appearance with a coat of paint and the right decorative accessories. Other times, it may be desirable to alter the decorative appearance more frequently through the interchange of decorative touches such as throw pillows, flowers and similar decorative accessories.

In the past, hardware pieces such as knobs and pulls for cabinets and furniture were considered fixtures which were interchanged during remodeling or redecorating of the room. Although offered in a variety of shapes, finishes and colors, the prior known hardware was secured to the cabinet or furniture using a threaded fastener. As a result, interchange required substitution with a hardware piece of a nearly identical footprint. Otherwise, consumers would simply retain the hardware in any redecorating of a room.

### SUMMARY OF THE PRESENT INVENTION

The present invention overcomes the disadvantages of the prior known cabinet and furniture hardware by providing a fascia member which may be removed and replaced to alter the appearance of the hardware piece.

The hardware piece of the present invention is a knob or pull adapted to be secured to a door, drawer or face of a cabinet or furniture piece. The knob or pull may be any desired configuration and includes a foot for connecting the hardware to the cabinet or furniture piece. The body of the knob or pull will have a face capable of receiving an interchangeable face capable of receiving an interchangeable fascia member. The interchangeable fascia member may be used to change any aesthetic aspect of the hardware including color, design or shape.

In a preferred embodiment of the invention, the face of the hardware piece includes a recess forming a seat configured to receive the fascia member. Since the body of the hardware piece can be formed of any number of materials including wood, ceramic, plastic or metal, a metal backing plate is mounted in the recess. The fascia member includes a magnetic backing such that magnetic attraction to the metal plate holds the fascia member within the recess. As desired, the fascia member may be removed and replaced by overcoming the magnetic attraction.

Other objects, features and advantages of the invention will be apparent from the following detailed description taken in connection with the accompanying drawings.

### BRIEF DESCRIPTION OF THE DRAWING

The present invention will be more fully understood by reference to the following detailed description of a preferred embodiment of the present invention when read in conjunction with the accompanying drawing in which like reference characters refer to like parts throughout the views and in which:

FIG. 1 is an exploded view of a hardware piece with an interchangeable fascia embodying the present invention;

FIG. 2 is a cross-sectional view of the hardware piece with a removal tool; and

FIG. 3 is an enlarged partial cross-sectional view of the hardware piece.

### DETAILED DESCRIPTION OF A PREFERRED EMBODIMENT OF THE PRESENT INVENTION

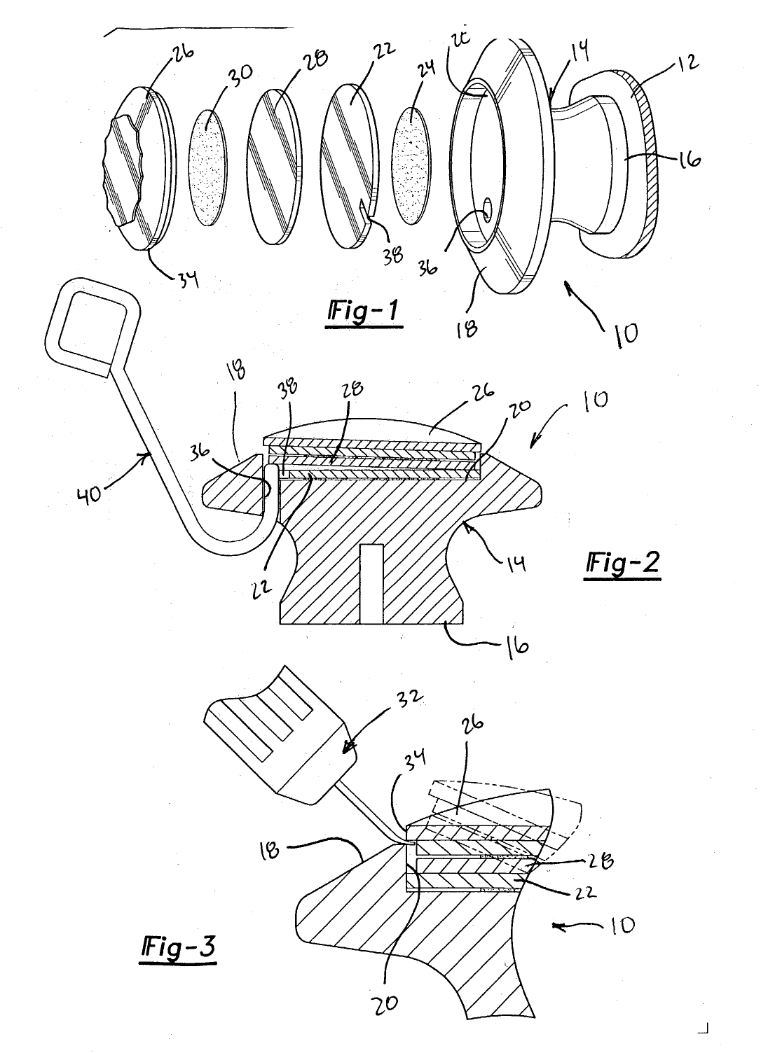

Referring first to FIG. 1, there is shown a hardware piece 10 in the form of a knob adapted to be mounted to a furniture piece or cabinet 12. The hardware piece 10 is typically mounted to a drawer or door of the cabinet 12 to facilitate opening and closing. A plurality of matching hardware pieces 10 may be mounted to the furniture in order to provide a decorative accent. Although the present invention will be shown and described in conjunction with a substantially circular knob 10, it should be understood that the inventive concept can be applied to knobs of varying configurations and to pull handles having an elongated configuration.

The hardware piece 10 includes a body 14 with a foot 16 engaging the cabinet 12. The piece 10 is secured to the cabinet 12 using a threaded fastener (not shown) engaging the foot 16. The body 14 of the hardware piece 10 extends from the foot 16 to a front portion forming a face 18.

Referring now to FIGS. 1 through 3, in a preferred embodiment of the present invention, the front face 18 of the piece 10 includes a recess 20 formed across a substantial portion of the face 18. Although shown as circular, the recess 20 could be any desired configuration corresponding to the shape of the hardware piece 10. Disposed within the recess 20 is a magnetic disc 22. Preferably, the magnetic disc 22 is secured within the recess 20 using an adhesive 24. The magnetic disc 22 is utilized to attract and maintain a fascia insert 26 within the recess 20. The insert 26 may be made of metal which will be magnetically attracted to the disc 22. Alternatively, the insert 26 may include a metal disc 28 mounted to the back of the insert 26 using adhesive 30 or other means. Accordingly, the decorative fascia 26 may be removably inserted to seat within the recess 20 being maintained within the recess 20 by the magnetic attraction of the disc 22.

Because the decorative fascia 26 is seated within the recess 20, a tool may be required to remove the fascia insert 26. In FIG. 3, a thin prying tool 32 is used to pry the peripheral edge 34 of the insert 26 until the insert 26 is lifted from the recess 20. An alternative is shown in FIG. 2. A throughbore 36 is formed in the hardware piece 10 in communication with the recess 20 and open to the exterior of the piece 10. In order to accommodate the removal tool 40, the magnetic disc 22 is provided with a slot or aperture 38. While mounting the magnetic disc 22 within the recess 20, the slot 38 is aligned with the bore 36. When removal of the decorative fascia 26 is desired, the tool 40 is inserted through the bore 36 to push one end of the insert 26 out of the recess 20 facilitating removal of the decorative insert 26.

In accordance with the present invention, the appearance of the hardware 10, and as a result, the cabinet 12 can be altered simply by replacing the decorative insert 26. The insert may be a different color or finish or may include a different design allowing the consumer to change the decorative appearance as desired. With certain hardware pieces 10, the recess 20 could be eliminated allowing the fascia piece to be applied to the face 18. As a further alternative, the magnetic material could be carried by the insert 26 inserted of within the recess 20. Nevertheless, the present invention provides a simple means of changing the appearance of the hardware pieces 10 giving the consumers a variety of decorative alternatives.

The foregoing detailed description has been given for clearness of understanding only and no unnecessary limitations should be understood therefrom as some modifications will be obvious to those skilled in the art without departing from the scope and spirit of the appended claims.

What is claimed is:

1. A hardware piece adapted to be mounted to a surface, said hardware piece comprising:
a body having a front face; and
a fascia member removably attached to said face of said body to alter the appearance of said hardware piece.

2. The hardware piece as defined in claim 1 wherein said fascia member is magnetically attached to said body.

3. The hardware piece as defined in claim 2 wherein said face includes a recess, said fascia member being removably seated within said recess.

4. The hardware piece as defined in claim 3 wherein said recess extends across substantially the entirety of the body face.

5. The hardware piece as defined in claim 3 wherein said recess includes a magnetic disc positioned within said recess.

6. The hardware piece as defined in claim 5 wherein said body includes a throughbore in communication with said recess, said throughbore adapted to receive a tool for removing said fascia member from said recess.

7. The hardware piece as defined in claim 6 wherein said hardware piece is a knob.

8. The hardware piece as defined in claim 6 wherein said hardware piece is a pull handle.

9. A hardware piece adapted to be mounted to a surface, said hardware piece comprising:
a body having a front face, said front face including a recess formed therein; and
a fascia member removably seated within said recess of said front face, said fascia member being interchangeably removable from said body to alter the appearance of said hardware piece.

10. The hardware piece as defined in claim 9 wherein said recess includes a magnetic member to magnetically seat said fascia member within said recess.

11. The hardware piece as defined in claim 10 wherein said recess extends across substantially the entirety of said body face.

12. The hardware piece as defined in claim 10 wherein said body includes a throughbore in communication with said recess, said throughbore adapted to receive a tool for removing said fascia member from said recess.

13. The hardware piece as defined in claim 12 wherein said hardware piece is a knob.

14. The hardware piece as defined in claim 12 wherein said hardware piece is a pull handle.
